(19) United States
(12) Patent Application Publication
(10) Pub. No.: US 2026/0015368 A1
(43) Pub. Date: Jan. 15, 2026

(54) METHOD FOR SYNTHESISING ECO-FRIENDLY MOFS, IN PARTICULAR FLEXIBLE MOFS

(71) Applicants: CENTRE NATIONAL DE LA RECHERCHE SCIENTIFIQUE, Paris (FR); ÉCOLE NORMALE SUPERIEURE, Paris (FR); ÉCOLE SUPÉRIEURE DE PHYSIQUE ET DE CHIMIE INDUSTRIELLES DE LA VILLE DE PARIS, Paris (FR)

(72) Inventors: Georges MOUCHAHAM, Tours (FR); Christian SERRE, Plaisir (FR); Farid NOUAR, Montigny-le-Bretonneux (FR); Shyamapada NANDI, Vitry sur Seine (FR)

(21) Appl. No.: 19/114,398

(22) PCT Filed: Sep. 21, 2023
(86) PCT No.: PCT/FR2023/051447

§ 371 Date: Mar. 21, 2025

(30) Foreign Application Priority Data
Sep. 22, 2022 (FR) FR2209594

(51) Int. Cl. C07F 5/06; C07F 15/02

(52) U.S. Cl. CPC C07F 5/069; C07F 15/025

(57) ABSTRACT

The invention relates to a method for producing a MOF, wherein a MOF is a structured metal-organic compound comprising a bi- or tri-dimensional porous network consisting of inorganic entities that are connected by polydentate chelating ligands bonded to multiple metal centers; the polydentate chelating ligands being selected in particular from the group comprising C5-C24 heteroaromatic ligands and aromatic ligands, comprising at least one carboxylic acid function, preferably benzyl or naphthyl di-, tri- or tetracarboxylate, and the aromatic or heteroaromatic ligands optionally bearing, on at least one aromatic ring, a group selected from among —NH2, —OH, —CH3, —NO2, —CF3, —COOH, —SO3H, —SH, —OCH3.

The present invention belongs to the field of the synthesis of coordination polymers, and more particularly pertains to the preparation of crystallised metal-organic structures, also referred to as structured metal-organic frameworks, or MOFs, according to synthetic pathways not yet explored, and which are eco-friendly. A compound is said to be eco-friendly when its release into the natural environment is acceptable. An eco-friendly MOF compound does not cause foreseeable or identifiable dysfunctions or significant changes in the ecological balance thereof, and corresponds to a MOF for which the preparation, use and end-of-life disposal are environmentally friendly in accordance with the article: “MOFs industrialization: a complete assessment of production costs, Maria Inês Severino, Effrosyni Gkaniatsou, Farid Nouar, Moises L. Pinto, Christian Serre, Faraday Discuss., 2021, 231, 326”.

The bibliographical references in the following text are noted in this way in the text of the description; and listed in the table of references.

### STATE OF THE ART

The preparation and the study of structured metal-organic frameworks, is a field of coordination chemistry in its own right, with clearly identified applications in the capture of toxic gases [1-5], gas storage [6-7], separation techniques [8-12], catalysis and electrocatalysis of small molecules [13-15], heat reallocation [16, 17], water recovery [18], detection [19], biological applications [20], etc. In most of the targeted industrial applications, particularly gas separation, gas storage, heat reallocation and water recovery, the target MOF must be produced on a very large scale according to an environmentally friendly method with a minimal energy cost.

However, the number of MOFs that can be produced in large quantities on an industrial scale remains very limited compared to the number of MOFs known to date [21]. However, the synthetic pathways identified to date, of the vast majority of MOFs only have recourse to the hydrothermal or solvothermal technique, which technique requires a large amount of energy impacting the final production cost. This is not compatible with simple methods such as heating at ambient pressure, while making it possible to preserve or consider the use of green solvents such as the aqueous water/alcohol mixture [22].

Among the various classes of known MOFs, those based on trivalent metal carboxylates, in particular those containing Al, are considered to be the most promising for industrial applications due to the greater hydrolytic stability thereof compared to MOFs based on divalent metal carboxylates [23-26]. MIL-53(Al), an Al dicarboxylate, is a very stable, MOF of reference, with a flexible framework [27].

With regard to the high structural flexibility and excellent water stability thereof, this MOF was studied for a wide range of potential applications such as gas separation [28-30], gas storage [31], catalysis [32, 33], detection [34], mechanical energy storage [35], nonlinear optics [36], etc. It was also demonstrated that the flexibility of this MOF could be used for CO₂ separation (adsorption followed by regeneration) in the presence/absence of external stimulus, such as mechanical pressure [37].

Other flexible MOFs of interest are solids of MIL-53 structure but with a functional group on the organic spacer of the MOF: MIL-53(Al)—NH₂ and MIL-53(Al)—OH [38-41].

These flexible MOFs must generally be prepared under hydro- or solvothermal conditions, which are not very compatible with large-scale production. To overcome this drawback, one of the objectives of the present invention consists in producing MOFs using an innovative method implementing techniques that are easy to implement, such as heating at ambient pressure, using commercial starting materials and green solvents such as water, alcohols or a mixture thereof.

Although the synthesis of MIL-53(Al) has been reported according to several protocols, whether by precipitation at ambient temperature using water as solvent, an environmentally friendly method [43], the use of metal salts requires diluted solutions which considerably reduces the spatio-temporal yield (STY) and makes this method unrealistic from an industrial point of view. Furthermore, to design flexible aluminium-based MOFs, such as MIL-53(Al), the use of AL(NO₃)₃·6H₂O as source of AL³⁺ entails a significant chemical risk (nitrates) which makes the production thereof less obvious on the industrial scale, which demonstrates that there is a real need to develop alternative synthesis methods.

Although Biswas et al. described a method for synthesising several functionalised MIL-53(Al) structures starting from AlCL₃·6H₂O [44], this method involves the hydrothermal or solvothermal pathway, with the aforementioned drawbacks with regards to industrial requirements.

Mention may also be made, as prior art, of the following syntheses:
the synthesis of MIL-53(Fe) and MIL-53(Fe)—NH₂ implementing green solvents such as water as solvent and a water-ethanol mixture as washing solution, but requiring high temperature and pressure conditions (hydro/solvothermal pathway) [45, 46];
the synthesis of a MOF, more precisely In(OH)BDC·0.75BDCH₂, again under solvothermal conditions in the presence of hydrofluoric acid and N—N-dimethylformamide (so called DMF), DMF being known per se as a toxic solvent [47]; and
the synthesis by microwave heating, of MIL-53(X), wherein X is aluminium or chromium, at ambient pressure [48] using a mixture of water and of organic solvent (which may be DMF or dimethyl sulphoxide, also called DMSO) and using exclusively DMF as washing solution.

To overcome these drawbacks, one of the objectives of the present invention consists in being able to produce MOFs using an innovative method implementing techniques that are easy to implement, such as heating at ambient pressure, from commercial, inexpensive constituents and green solvents such as water, (ethyl) alcohol, DMSO or a mixture containing water in a high proportion.

### DESCRIPTION OF THE INVENTION

The present invention relates to a method for producing a MOF, a MOF being a structured metal-organic compound comprising a bi- or tri-dimensional porous framework consisting of inorganic entities connected by polydentate chelating ligands bonded to a plurality of metal centers; said polydentate chelating ligands being selected from the group comprising:
C₄-C₂₄ aliphatic ligands comprising at least one carboxylic acid function, selected from ligands including a linear alkyl chain without unsaturation and ligands comprising carbon chains including at least one unsaturation, such as fumaric acid or muconic acid;
C₄-C₂₄ heteroaromatic ligands and aromatic ligands comprising at least one carboxylic acid function, preferably benzyl or naphthyl di-, tri- or tetracarboxylate, and said aromatic or heteroaromatic ligands, optionally bearing on at least one aromatic ring, a group selected from —NH₂, —OH, —CH₃, —OCH₃, —NO₂, —CF₃, —COOH, —SO₃H, —SH; said method comprising the following steps of:
a) dispersing in water a molecule of polydentate chelating ligand, and at least one metal precursor (i.e. at least one metal salt), preferably selected from metal sulphate salts and metal chlorate salts, preferably an aluminium sulphate salt;
b) optionally heating the dispersion obtained in a) at ambient pressure and maintaining it at a temperature of 50 to 150° C., for a period from 10 minutes to 96 hours;
c) allowing to return to ambient temperature, filtering and washing the obtained solid with water;
d) drying the solid obtained in c);
e) dispersing under stirring the solid obtained in d) in a solution comprising or even consisting of DMSO for a period from 30 minutes to 15 hours, at a temperature of less than or equal to 150° C.

The inventors demonstrated that it was possible to carry out syntheses of MOFs in water, thanks to a subsequent step of washing with DMSO, making it possible to remove untransformed reagents. Conventional synthesis methods usually require the synthesis (or at least the washing step) to be carried out in toxic solvents, such as DMF, so that the impurities are removed with the washing solvent and do not remain confined in the pores of the MOFs, all while heating for several days the solid in the solution brought to 150° C.

It is specified that, in the foregoing and following, the terms washing and activation are understood in the same way and can therefore be absolutely interchangeable.

The inventors have also demonstrated that the use of DMSO during the washing step made it possible to reduce the time of this step compared to such a washing step carried out with DMF. Indeed, thanks to the relatively higher polarity of DMSO and the better solubility of some ligands in this solvent—compared to DMF—untransformed reagents are removed more quickly.

Within the scope of the invention, the term “aromatic group” refers to stable, substituted or unsubstituted, unsaturated mono- or polycyclic hydrocarbon-based fragments, preferably having 3 to 14 carbon atoms, comprising at least one cycle satisfying the Hückel rule for aromaticity.

The term “heteroaromatic group”, as used within the scope of the invention, designates stable, substituted or unsubstituted, monoheterocyclic or polyheterocyclic fragments, preferably having 3 to 14 carbon atoms, comprising at least one cycle satisfying the Hückel rule for aromaticity. Examples of heteroaromatic entities comprise, but are not limited to, furanyl, pyridinyl (pyridine radical), indolinyl (indole radical), imidazolinyl (imidazole radical), pyrrolinyl (pyrrole radical), quinolinyl, dihydroquinolinyl, isoquinolinyl, quinazolinyl, dihydroquinazolyl, and tetrahydroquinazolyl groups. Among the ligands including such a group, mention may be made of 2,5 FDCA·2,5-furanedicarboxylic acid.

Preferably, the polydentate chelating ligand is selected from at least one type of ligand selected from a bidentate ligand, a tridentate ligand and a tetradentate ligand, and advantageously comprises C₆-C₂₄ aromatic compounds including at least one function selected from a carboxylic acid, phosphonic acid, amine, alcohol, ketone and azole function; preferably the polydentate chelating ligand is selected from at least one of the ligands: benzene-1,4-dicarboxylic acid or terephthalic acid (C₈H₆O₄, CAS: 100-21-0, known under the abbreviation 1,4-BDC, BDC, H₂-BDC or BDCH₂), nitro-terephthalic acid (C₈H₅NO₆, CAS:610-29-7, known under the abbreviation NO₂-1,4-BDC), 2-amino-terephthalic acid (C₈H₅NO₄, CAS:10312-55-7, known under the abbreviation NH₂-1,4-BDC), 2-chloroterephthalic acid (C₈H₅ClO₄, CAS:1967-31-3, known under the abbreviation Cl-1,4-BDC), 1,3,5-benzenetricarboxylic acid (C₆H₃(CO₂H)₃, CAS: 554-95-0), 3,3′,5,5′-azobenzenetetracarboxylic acid (C₁₆H₁₀N₂O₈, CAS: 365549-33-3), 3,5-pyrazoledicarboxylic acid (C₅H₄N₂O₄, CAS: 303180-11-2), 2,5-bis(trifluoromethyl)-1,4-benzenedicarboxylic acid (C₁₀H₄F₆O₄, CAS: 366008-67-5), 2-(trifluoromethyl)-1,4-benzenedicarboxylic acid (C₉H₅F₃O₄, CAS: 1483-47-2), 1,2,4-triazole (C₂H₃N₃, CAS: 288-88-0), 2-methylimidazole (C₄H₆N₂, CAS: 693-98-1), N,N′-piperazine(methylenephosphonic) acid (C₆H₁₆N₂O₆P₂, CAS: 89280-71-7), L-aspartic acid (C₄H₇NO₄, CAS: 56-84-8), 2,5-dihydroxydeterephthalic acid (C₈O₆H₆, CAS: 610-92-4) and 3,4-dihydroxy-3-cylobutene-1,2-dione (C₄O₄H₂, CAS: 2892-51-5).

Advantageously, DMSO is removed by rinsing in a step f) of treatment with ethanol after step e).

Preferably, the metal center of the method for producing a MOF according to the invention comprises at least one metal selected from Cu, Zn, Ca, Mg, Ti, Zr, In, Ga, V, Cr, Mn, Fe and Al, preferably the metal is a metal ion selected from at least one metal ion of Fe, Al, Cr and Zr, even more preferably selected from at least one metal ion of Fe, Al, Cr and V.

Preferably, the MOF prepared according to the method of the invention is selected from MIL-53, MIL-68, MIL-69, MIL-101, MIP-206, and DUT-7. In a particularly preferred manner, it is an MOF selected from MIL-53(Al), MIL-53(Fe), MIL-53(Cr), MIL-68(Al), MIL-68(Fe), MIL-68(Cr) and MIP-206(Zr).

Preferably, wherein the MOF is selected from the MIL-53 class comprising a metal ion in oxidation state +3 of a metal selected from Cr, Al, Fe, V, Ga and In, and the aromatic ligand is benzene-1,4-dicarboxylic acid or a derivative.

Preferably, the benzene-1,4-dicarboxylic acid derivative is benzene-1,4-dicarboxylic acid substituted on the aromatic ring by at least one group selected from: —NH₂, —OH, —CH₃, —NO₂, —CF₃, —COOH, —SO₃H, —SH, —OCH₃, and preferably a group —NH₂, —OH and —NO₂.

Such ligands may, for example, be NO₂-1,4-BDC, NH₂-1,4-BDC, or even Cl-1,4-BDC.

In accordance with the invention, a base can be added during step a), such as sodium hydroxide, piperazine or urea.

Preferably, the metal sulphate implemented in step a) is Al₂(SO₄)₃·16H₂O and preferably urea is added to the dispersion in step a).

Preferably, wherein the metal chlorate implemented in step a) is FeCl₃·6H₂O.

Preferably, step b) is maintained for 8 h and 48 hours; and in step e) the dispersion is heated to a temperature less than or equal to 130° C. for 1 to 4 h, with vigorous mechanical stirring.

Another object of the present invention relates to a MOF of the MIL-53 class, selected from MIL-53(Al), MIL-53(Al)—NH₂, MIL-53(Al)—NO₂, MIL-53(Al)—OH, MIL-53(Fe) and MIL-53(Cr), prepared according to the method as described above without the use of DMF, and not involving a calcination step.

The particle size is evaluated by imaging, preferably by SEM microscopy.

The present invention also relates to the use of a MOF as described within the scope of the present invention for the separation (gases, vapours, etc.); in particular the capture of CO₂ (post-combustion, pre-combustion, or biogas); the separation of aromatics (xylenes), aliphatics (branched alkanes); the capture of volatile organic compounds; the water-alcohol purification; the desalination, the materials for batteries, the catalysis such as the dehydrogenation of alcohols, or if the MOF is doped or combined with a co-catalyst, for the adsorption and conversion of small molecules (CO₂, CH₄, NH₃, etc.); the heat lost management for example by adsorption-flexibility compensation; and the detection; the separation or the controlled storage/release by stimuli such as pressure, electric current, microwave irradiation, and magnetic field.

Within the scope of the present invention, the BET specific surface area as well as the volume of the pores, were determined by the N₂ adsorption method, on the basis of the N₂ adsorption-desorption isotherms at −196° C. (77K), measured particularly with a Micromeritics® TriStar device.

Advantageously, a “degassing” step (i.e. heating under vacuum) can be implemented for the preparation of the samples before the sorption isotherm measurement, this step may follow step f) mentioned above.

The present invention is also described in the following detailed description, wherein the experimental part details some embodiments using examples, given only by way of illustration and which should not be considered as restrictive, and the figures briefly described in the following part.

### BRIEF DESCRIPTION OF THE FIGURES

FIG. 1 shows the FTIR spectra of MIL-53(Al) (synthesised using SO₄ salt) and the activated form thereof compared to the free ligand;

FIG. 2 shows the FTIR spectra of MIL-53(Al)—NO₂ (synthesised using SO₄ salt) and the activated form thereof compared to the free ligand;

FIG. 3 shows the FTIR spectra of MIL-53(Al)—NH₂ (synthesised using SO₄ salt) and the activated form thereof compared to the free ligand;

FIG. 4 shows a comparative powder X-ray diffractogram (PXRD plot) of MIL-53-(Al) synthesised from SO₄ salt. The sample washed with DMSO then dried at 100° C. exists mainly in a narrow pore (np) configuration as opposed to large pore (lp) configuration;

FIG. 5 shows a comparative FTIR plot of MIL-53(Al) synthesised from SO₄ salt. Washing with DMSO followed by drying at 100° C. produces a MIL-53 sample that is free of any ligand within the pore;

FIG. 6 shows a comparative PXRD plot of MIL-53(Al) synthesised from chloride salt between an unactivated form and an activated form (vacuum dried at 100° C.);

FIG. 7 shows a comparative PXRD plot of MIL-53(Al)—NO₂ synthesised from chloride salt between an unactivated and an activated form;

FIG. 8 shows a comparative PXRD plot of MIL-53(Al)—NH₂ synthesised from chloride salt between an unactivated and an activated form;

FIG. 9 shows FTIR spectra of MIL-53(Al) and of the activated form thereof (synthesised from chloride salt) compared to the ligand;

FIG. 10 shows FTIR spectra of MIL-53(Al)—NO₂ and the activated form thereof (synthesised from chloride salt) compared to the ligand;

FIG. 11 shows FTIR spectra of MIL-53(Al)—NH₂ and the activated form thereof (synthesised from chloride salt) compared to the ligand;

FIG. 12 shows the thermogravimetric analysis curve (TGA) of MIL-53(Al) (synthesised using SO₄ salt) showing the thermal stability of the structure before and after activation;

FIG. 13 shows the thermogravimetric analysis curve (TGA) of MIL-53(Al)—NO₂ (synthesised using SO₄ salt) before and after activation;

FIG. 14 shows the thermogravimetric analysis curve (TGA) of MIL-53(Al)—NH₂ (synthesised using SO₄ salt) before and after activation;

FIG. 15 shows the thermogravimetric analysis curve (TGA) of MIL-53(Al) (synthesised using chloride salt);

FIG. 16 shows the thermogravimetric analysis curve (TGA) of MIL-53(Al)—NO₂ (synthesised using chloride salt);

FIG. 17 shows the thermogravimetric analysis curve (TGA) of MIL-53(Al)—NH₂ (synthesised using chloride salt);

FIG. 18 shows the 77K N₂ isotherms of MIL-53(Al) synthesised using a chloride salt. Activation by calcination produces the sample with a slightly smaller surface area than activation by DMSO washing;

FIG. 19 shows a comparative powder X-ray diffractogram (PXRD plot) of MIL-53(Fe)—Cl;

FIG. 20 shows the FTIR spectra of MIL-53(Fe)—Cl and the activated form thereof compared to the free ligand; and

FIG. 21 shows the thermogravimetric analysis curve (TGA) of MIL-53(Fe)—Cl).

### EXPERIMENTAL PART

### Material and Methods

The reagents used are marketed by Alfa Aesar® and used without further purification.

### Instrumentation

PXRD: The powder X-ray diffraction (PXRD) data were collected using a Bruker® D8 Advance high throughput diffractometer working in transmission mode and equipped with a focusing Göbel mirror. The X-ray source was Cu-Kα radiation (λ=1.5418 Å).

### Sorption Measurement

All nitrogen porosimetry data were collected on a Micromeritics® TriStarinstrument at 77K. The isotherms of CO₂ and N₂ at 298K were recorded on a Micromeritics® Triflex instrument. In all cases, the measurements were recorded using ultra-high purity gases (grade ≥4.8). Before the adsorption measurement, all of the samples were degassed at a certain temperature (180-200° C.) for 8 hours. Degassing was performed in a single step using a Micromeritics® SmartVacPrep degassing unit: evacuation at 180-200° C. at the degassing port (P=10⁻⁶ mbar), the degassing rate then being <2 μbar/min.

TGA: The TGA data were collected on a Mettler Toledo® TGA/DSC 2, STAR System with a heating rate of 5° C./min under oxygen flow.

FTIR: The infrared spectra were measured with a ThermoFisher™ Nicolet iS5 FTIR spectrometer.

The observation of the surface topography of the samples was performed by scanning electron microscopy (SEM) using a FEI Magellan 400™.

The particle size distribution is carried out with SEM and the particle size measurements are carried out with ImageJ™ software.

Within the scope of the invention, a mass percentage expressed in % w/w, defines the mass percentage of an ingredient used in the preparation and considered with respect to the total mass of the considered object: a mixture, a material (composite, etc.), a membrane, etc.

### EXAMPLES

### Part 1: Syntheses

The synthesis of MIL-53(Al), and of the derivatives thereof, is optimised using various metal salts such as AlCl₃·6H₂O, Al₂(SO₄)₃·16-18H₂O, Al(OH)(CH₃COO)₂·xH₂O, Al(OH)₃ and NaAlO₂ in the presence of various bases (NaOH, urea). Sulphate and chloride salts are reagents of choice for obtaining MIL-53(Al) MOFs. The synthesis methods implementing these sulphate (Ex. 1-3) and chloride (Ex. 4-6) salts of said MIL-53 MOFs are described below.

### Example 1

### MIL-53(Al) Preparation

MIL-53(Al) is synthesised using the reflux technique. 100 mmol (66.6 g) of Al₂(SO₄)₃·16H₂O, 100 mmol (16.6 g) of 1,4-BDC (CAS: 100-21-0) and 100 mmol (6.0 g) of urea are dispersed in 200 ml of water in a 500 ml flask. The mixture is heated to reflux to 120° C. and maintained at reflux for 12 hours. After cooling of the reaction mixture at ambient temperature, the colourless powder is filtered and washed with 80 ml of water. The sample is then dried in air overnight. The product as synthesised contains free 1,4-BDC. Free 1,4-BDC is removed from the sample by washing with dimethyl sulphoxide (DMSO):

### MIL-53(Al) Activation

The synthesised MIL-53(Al) powder (22.5 g) is suspended in 250 ml of DMSO in a 500 ml flask. The mixture is then heated to 120° C. under continuous stirring and maintained for approximately 2 hours under these conditions. After cooling to 50° C., the suspension is centrifuged and washed with ethanol (70 ml), then with water (100 ml). The product is then dried in an oven at 100° C. The isolated product mass is 18.5 g.

Alternatively, the activation can also be carried out by calcination of the MIL-53(Al) sample in air, at 330° C. for 36 h. These reaction conditions of activation by calcination at high temperature are not very compatible with industrial scale implementation.

### Example 2: (Outside of the Invention)

### MIL-53(Al)—NO₂ Preparation

The synthesis is carried out using the reflux technique. 100 mmol (66.6 g) of Al₂(SO₄)₃·16H₂O, 100 mmol (21.1 g) of nitro-terephthalic acid (NO₂-1,4-BDC, CAS: 610-29-7) and 100 mmol (6.0 g) of urea were dispersed in 200 ml of water in a 500 ml flask. The mixture was then brought to reflux at 120° C. and maintained at reflux for 12 hours. After cooling the reaction mixture to ambient temperature, the colourless powder was filtered and washed with 80 ml of water. The sample was then dried in air (overnight). The product as synthesised contains free nitro-terephthalic acid. It is removed from the sample by washing with ethanol (EtOH):

### MIL-53(Al)— NO₂ Activation

The synthesised powder (26.5 g) is suspended in 250 ml of EtOH in a 500 ml flask. The mixture was then heated to 100° C. under continuous stirring and maintained for about 4 hours under these conditions. After cooling to 50° C., the suspension was filtered then rinsed with ethanol (60 ml). The product was then dried in an oven at 100° C. The isolated product mass is 22.5 g.

### Example 3

### MIL-53(Al)—NH₂ Preparation

The synthesis is carried out using the reflux technique. 100 mmol (66.6 g) of Al₂(SO₄)₃·16H₂O, 100 mmol (18.1 g) of 2-amino-terephthalic acid (NH₂-1,4-BDC, CAS: 10312-55-7) and 100 mmol (6.0 g) of urea were dispersed in 200 ml of water in a 500 ml flask. The mixture was then brought to reflux at 120° C. and maintained at reflux for 12 hours. After cooling the reaction mixture to ambient temperature, the colourless powder was filtered and washed with 80 ml of water. The sample was then dried in air (overnight). The product as synthesised contains free 2-amino-terephthalic acid 1,4-BDC.

Free 2-amino terephthalic acid is removed from the sample by washing with dimethyl sulphoxide (DMSO):

### MIL-53(Al)— NH₂ Activation

The synthesised powder (25.5 g) is suspended in 250 ml of DMSO in a 500 ml flask. The mixture is then heated to 120° C. under continuous stirring and maintained for approximately 2 hours under these conditions. After cooling to 50° C., the suspension is centrifuged and washing with ethanol (70 ml) then with water (100 ml) is carried out. The product was then dried in an oven at 100° C. The isolated product mass is 19.0 g.

### Example 4

### MIL-53(Al) Preparation

MIL-53(Al) is synthesised using the reflux technique. 150 mmol (36.15 g) of AlCl₃·6H₂O are dissolved in 260 ml of water in a 500 ml flask and the solution was heated to 100° C. Then, 125 mmol (20.75 g) of 1,4-BDC dissolved in 65 ml of NaOH 2M are added to the flask under stirring. The mixture was then brought to reflux for 12 hours at 120° C. After that, the colourless gel was filtered and washed with 200 ml of water. The sample is then dried in air (overnight). The isolated product mass is 23.0 g. The product as synthesised contains free 1,4-BDC. Free 1,4-BDC is removed from the sample by washing with dimethyl sulphoxide (DMSO):

### MIL-53(Al) Activation

The synthesised powder (23.0 g) is suspended in 250 ml of DMSO in a 500 ml flask. The mixture was then heated to 120° C. under continuous stirring and maintained for approximately 2 hours under these conditions. After cooling to 50° C., the suspension is centrifuged followed by washing with ethanol (70 ml) then with water (100 ml). The product is dried in an oven at 100° C. The product is then dried in an oven at 100° C. The isolated product mass is 17.5 g.

Alternatively, the activation can also be carried out by calcination. The synthesised MIL-53(Al) powder is finely ground and spread well on a watch glass. Then the watch glass is placed in a programmable oven. The sample is heated to 330° C. (for 2 hours) and maintained at 330° C. for 36 hours. After cooling to ambient temperature, the powder is collected and characterised by PXRD, TGA and IR.

### Example 5: (Outside of the Invention)

### MIL-53(Al)—NO₂ Preparation

The synthesis is carried out using the reflux technique. 100 mmol (66.6 g) of AlCl₃·6H₂O are dissolved in 250 ml of water in a 500 ml flask and the solution was heated to 100° C. Then, 125 mmol (26.39 g) of nitroterephthalic acid dissolved in 65 ml of NaOH 2M (in a beaker) are added to the flask under stirring. An additional 20 ml of water is added to rinse the beaker. The mixture is then brought to reflux for 12 hours at 120° C. After that, the colourless solid is filtered and washed with 150 ml of water and rinsed with 50 ml of ethanol. The sample is then dried in air (overnight). The isolated product mass is 26.0 g. The product as synthesised contains free nitro-terephthalic acid.

It is removed from the sample by washing with ethanol (EtOH):

### MIL-53(Al)— NO₂ Activation

The synthesised powder is finely ground and placed in a 500 ml flask. 250 ml of ethanol are added. The product is brought to reflux at 100° C. for 10 hours and hot-filtered (about 60° C.) and washed with 40 ml of hot ethanol. The isolated product mass is 24.25 g.

Note: In some cases, the sample may contain some traces of free ligand after the first wash. In this case, it must be washed once more with 150 ml of ethanol (100° C. for 5 hours).

### Example 6

### MIL-53(Al)—NH₂ Preparation

The synthesis is carried out using the reflux technique. 150 mmol (36.15 g) of AlCl₃·6H₂O are dissolved in 200 ml of water in a 500 ml flask and the solution was heated to 100° C. Then, 125 mmol (22.64 g) of 2-amino-terephthalic acid (NH₂-1,4-BDC, CAS: 10312-55-7) dissolved in 120 ml of NaOH 2M (in a beaker) are added to the flask under stirring. 30 ml of water are added to rinse the beaker. The mixture is then brought to reflux for 12 hours at 120° C. After that, the yellowish solid is filtered and washed with 200 ml of water and rinsed with 30 ml of ethanol. The sample is then dried in air (overnight). The isolated product mass is 19.0 g. The product as synthesised contains free 2-amino-terephthalic acid NH₂-1,4-BDC.

Free 2-amino terephthalic acid is removed from the sample by washing with dimethyl sulphoxide (DMSO):

### MIL-53(Al)— NH₂ Activation

The powder thus synthesised is finely ground and placed in a 500 ml flask. 250 ml of DMSO are added. The mixture is brought to reflux at 120° C. for 2 hours. After cooling to 50° C., the suspension is centrifuged followed by washing with ethanol (70 ml) then with water (100 ml). The product was then dried in an oven at 100° C. The isolated product mass is 16.2 g.

### Example 7

### MIL-53(Fe)—Cl Preparation

The synthesis is carried out using the reflux technique. 15 mmol (4.10 g) of FeCl₃·6H₂O and 15 mmol (3.00 g) of 2-chloroterephthalic acid (Cl-1,4-BDC, CAS: 1967-31-3) are dissolved in 120 ml of water in a 250 ml flask. The mixture is then brought to reflux for 48 hours. After that, the colourless solid obtained is filtered and washed with 80 ml of water. The sample is then dried in air (overnight). The isolated product mass is 3.4 g. The product as synthesised contains free 2-amino-terephthalic acid 1,4-BDC.

Free 2-amino terephthalic acid is removed from the sample by washing with dimethyl sulphoxide (DMSO):

### MIL-53(Fe)—Cl Activation

The powder thus synthesised is finely ground and placed in a 100 ml flask. 50 ml of DMSO are added. The mixture is brought to reflux at 120° C. under stirring for 2 hours. After cooling to 50° C., the suspension is centrifuged followed by washing with ethanol (20 ml) then with water (15 ml). The product was then dried in an oven at 100° C. The isolated product mass is 3.0 g.

### Part 2: Analysis and Results

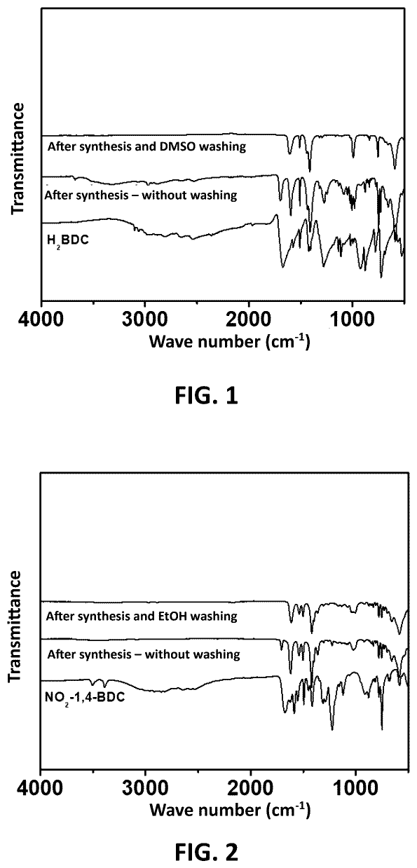

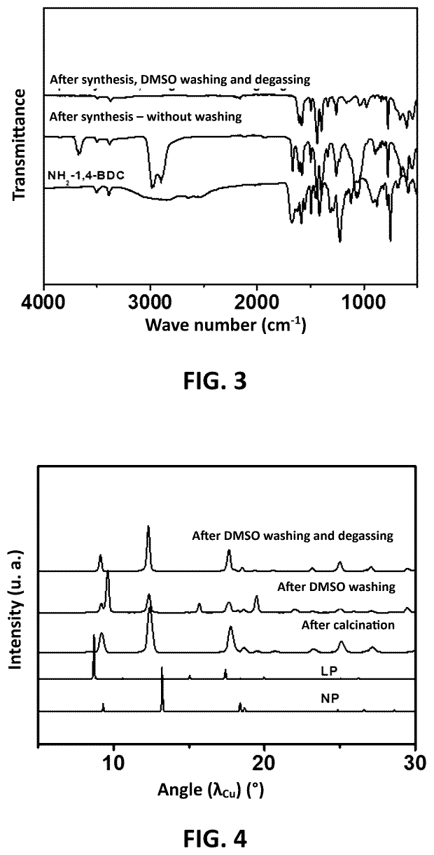

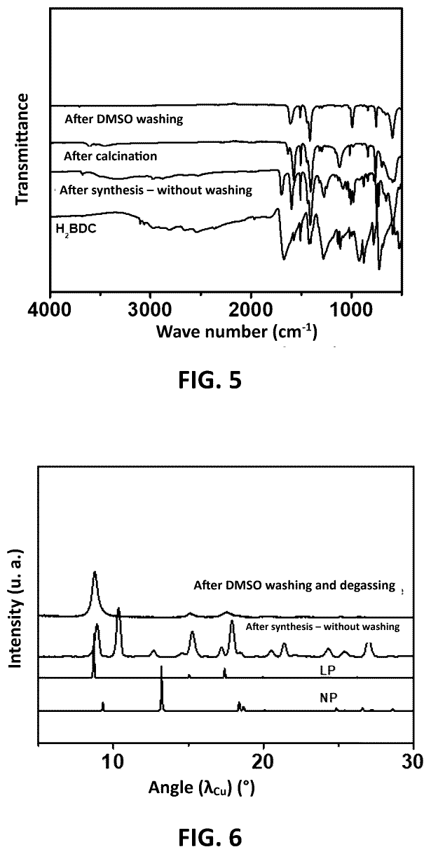

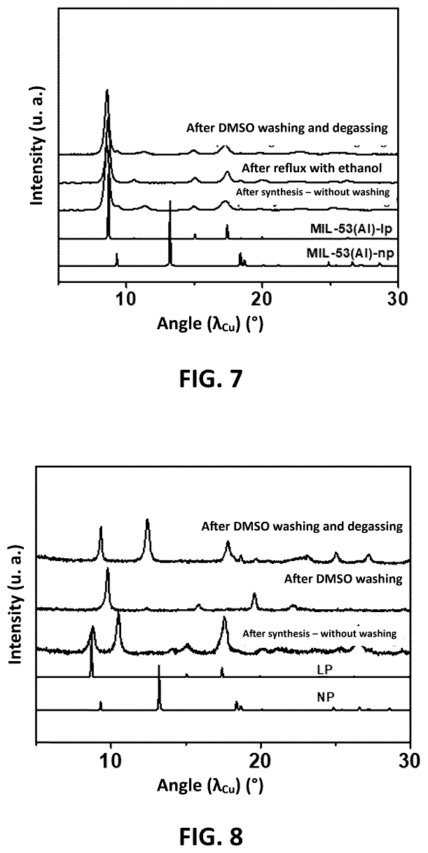

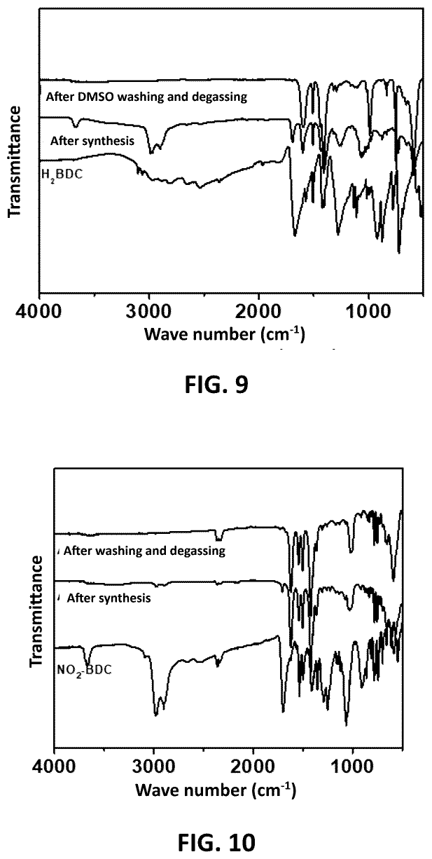

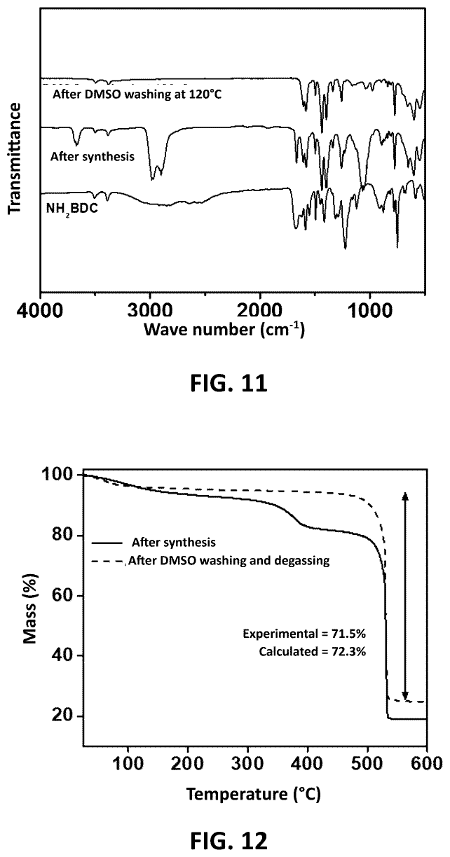

The comparison of the FTIR and PXRD spectra in FIGS. 1 to 11 shows that activation allows to remove all of the free ligand that has not reacted in the MOF synthesis.

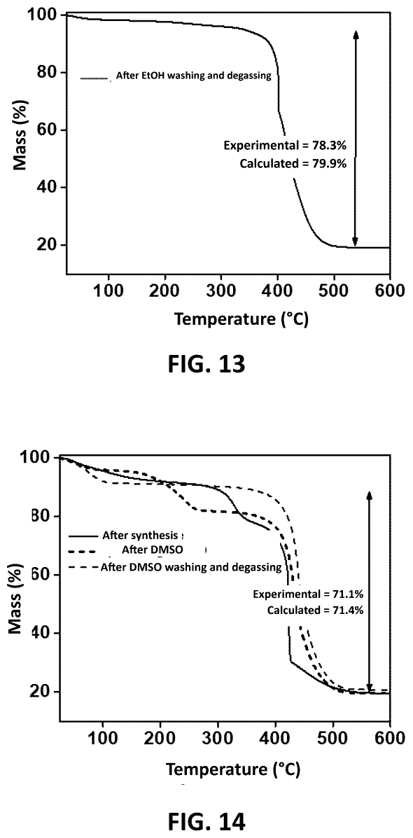

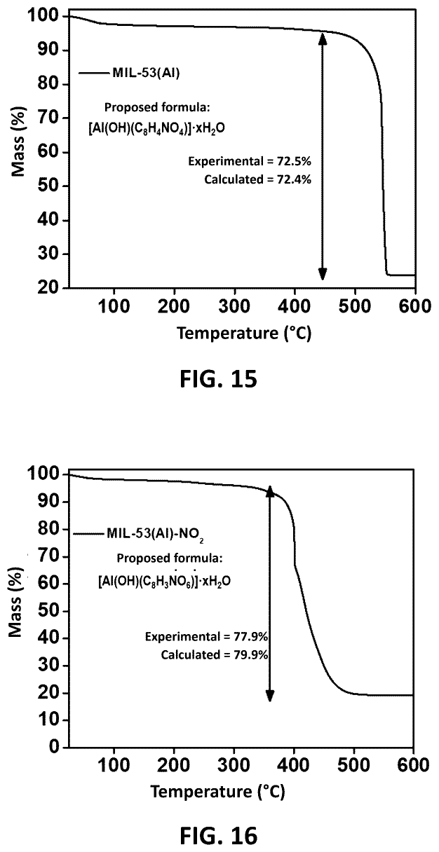

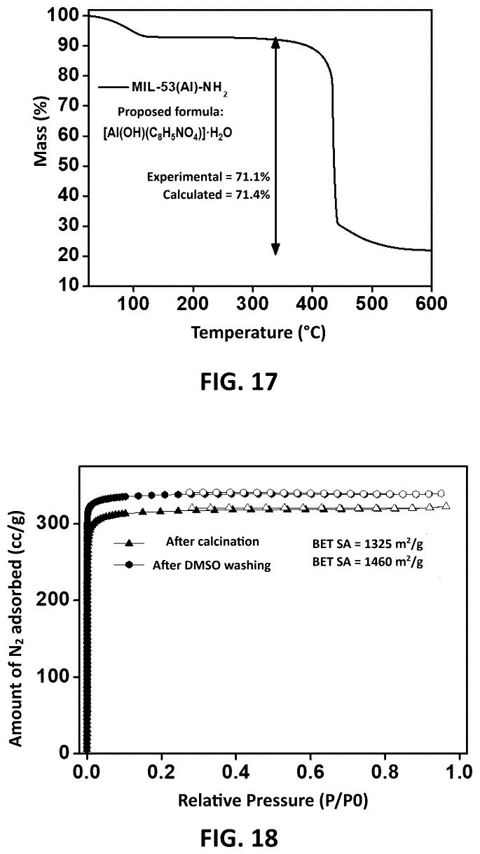

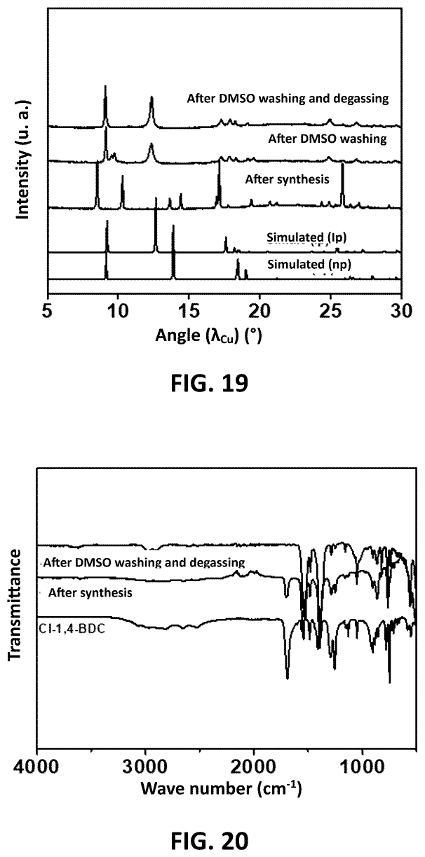

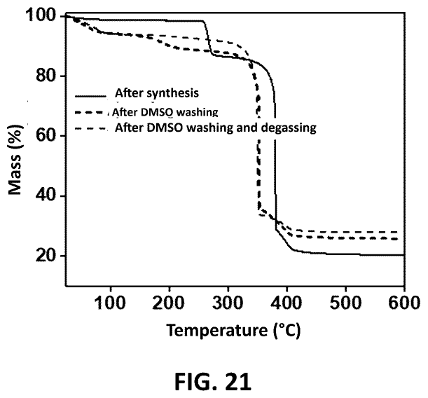

The comparison of thermogravimetric analysis (TGA) spectra in FIGS. 12 to 17 also shows that activation makes it possible to remove all of the free ligand that has not reacted within the MOF synthesis.

The gas absorption spectrum shown in FIG. 18 shows that activation by calcination produces a MIL-53(Al) MOF with a slightly smaller BET surface area than activation by washing with DMSO.

### REFERENCES

The following table lists the references mentioned above in the text:

TABLE 1

| | |
|---|---|
| 1 | Elisa Barea, Carmen Montoro and Jorge A. R. Navarro, Toxic |
| | gas removal - metal-organic frameworks for the capture and |
| | degradation of toxic gases and vapours, Chem. Soc. Rev., 2014, |
| | 43, 5419-5430 |
| 2 | Michelle Woellner, Steffen Hausdorf, Nicole Klein, Philipp |
| | Mueller, Martin W. Smith, Stefan Kaskel, Adsorption and |
| | Detection of Hazardous Trace Gases by Metal-Organic |
| | Frameworks, Adv. Mater. 2018, 30, 1704679 |
| 3 | Xue Han, Sihai Yang, Martin Schröder, Porous metal-organic |
| | frameworks as emerging sorbents for clean air, Nature Reviews |
| | Chemistry, 2019, 3, 108-118 |
| 4 | Joseph H. Carter, Xue Han, Florian Y. Moreau, Ivan da Silva, |
| | Adam Nevin, Harry G. W. Godfrey, Chiu C. Tang, Sihai Yang, |
| | and Martin Schröder, Exceptional Adsorption and Binding of |
| | Sulfur Dioxide in a Robust Zirconium-Based Metal-Organic |
| | Framework, J. Am. Chem. Soc. 2018, 140, 15564-15567 |
| 5 | M. R. Tchalala, P. M. Bhatt, K. N. Chappanda, S. R. Tavares, |
| | K. Adil, Y. Belmabkhout, A. Shkurenko, A. Cadiau, N. |
| | Heymans, G. De Weireld, G. Maurin, K. N. Salama & M. |
| | Eddaoudi, Fluorinated MOF platform for selective removal and |
| | sensing of SO2 from flue gas and air, Nat Commun, 2019, 10, |
| | 1328 |
| 6 | Jarad A. Mason, Mike Veenstrab and Jeffrey R. Long, |
| | Evaluating metal-organic frameworks for natural gas storage, |
| | Chem. Sci., 2014, 5, 32-51 |
| 7 | Bin Li, Hui-Min Wen, Wei Zhou, and Banglin Chen, Porous |
| | Metal-Organic Frameworks for Gas Storage and Separation: |
| | What, How, and Why?, J. Phys. Chem. Lett. 2014, 5, 3468- |
| | 3479 |
| 8 | M. Infas H. Mohideen, Renjith S. Pillai, Karim Adil, Prashant |
| | M. Bhatt, Youssef Belmabkhout, Aleksander Shkurenko, |
| | Guillaume Maurin, and Mohamed Eddaoudil, A Fine-Tuned |
| | MOF for Gas and Vapor Separation: A Multipurpose Adsorbent |
| | for Acid Gas Removal, Dehydration, and BTX Sieving, Chem, |
| | 2017, 3, 822-833 |
| 9 | H. C. J. Zhou; S. Kitagawa, Metal-Organic Frameworks |
| | (MOFs). Chem. Soc. Rev. 2014, 43, 5415-5418 |
| 10 | Z. Zhang; Z. -Z. Yao; S. Xiang; B. Chen, Perspective of |
| | microporous metal-organic frameworks for CO2 capture and |
| | separation. Energy Environ. Sci. 2014, 7, 2868-2899 |
| 11 | Xiang Zhao, Yanxiang Wang, Dong-Sheng Li, Xianhui Bu, |
| | Pingyun Feng, Metal-Organic Frameworks for Separation, |
| | Adv. Mater. 2018, 30, 1705189 |
| 12 | A. Kumar; D. G. Madden; M. Lusi; K. -J. Chen; E. A. Daniels; |
| | T. Curtin; J. J. Perry IV; M. J. Zaworotko, Direct Air Capture |
| | of CO₂ by Physisorbent Materials. Angew. Chem., Int. Ed. |
| | 2015, 54, 14372-14377 |
| 13 | Vlad Pascanu, Greco Gonzalez Miera, A. Ken Inge, and Belen |
| | Mart′ ín-Matute, Metal-Organic Frameworks as Catalysts for |
| | Organic Synthesis: A Critical Perspective, J. Am. Chem. Soc. |
| | 2019, 141, 7223-7234 |
| 14 | Nikolay Kornienko, Yingbo Zhao, Christopher S. Kley, |
| | Chenhui Zhu, Dohyung Kim, Song Lin, Christopher J. Chang, |
| | Omar M. Yaghi, and Peidong Yang, Metal-Organic |
| | Frameworks for Electrocatalytic Reduction of Carbon Dioxide, |
| | J. Am. Chem. Soc. 2015, 137, 44, 14129-14135 |
| 15 | Fuqin Zheng, Ziwei Zhang, Chunmei Zhang, and Wei Chen, |
| | Advanced Electrocatalysts Based on Metal-Organic |
| | Frameworks, ACS Omega, 2020, 5, 2495-2502 |
| 16 | Dirk Lenzen, Jingjing Zhao, Sebastian-Johannes Ernst, |
| | Mohammad Wahiduzzaman, A. Ken Inge, Dominik Fröhlich, |
| | Hongyi Xu, Hans-Jörg Bart, Christoph Janiak, Stefan |
| | Henninger, Guillaume Maurin, Xiaodong Zou & Norbert |
| | Stock, A metal-organic framework for efficient water-based |
| | ultra-low-temperature-driven cooling, Nat Commun, 2019, 10, |
| | 3025 |
| 17 | Sujing Wang, Ji Sun Lee, Mohammad Wahiduzzaman, Jaedeuk |
| | Park, Mégane Muschi, Charlotte Martineau-Corcos, Antoine |
| | Tissot, Kyung Ho Cho, Jérôme Marrot, William Shepard, |
| | Guillaume Maurin, Jong-San Chang & Christian Serre, A |
| | robust large-pore zirconium carboxylate metal-organic |
| | framework for energy-efficient water-sorption-driven |
| | refrigeration, Nat Energy, 2018, 3, 985-993 |
| 18 | Hyunho Kim, Sungwoo Yang, Sameer R. Rao, Shankar |
| | Narayanan, Eugene A. Kapustin, Hiroyasu Furukawa, Ari S. |
| | Umans, Omar M. Yaghi, Evelyn N. Wang, Water harvesting |
| | from air with metal-organic frameworks powered by natural |
| | sunlight, Science, 2017, 356, 430-434 |
| 19 | William P. Lustig, Soumya Mukherjee, Nathan D. Rudd, |
| | Aamod V. Desai, Jing Li and Sujit K. Ghosh, Metal-organic |
| | frameworks: functional luminescent and photonic materials for |
| | sensing applications, Chem. Soc. Rev., 2017, 46, 3242-3285 |
| 20 | Alistair C. Mckinlay, Russell E. Morris, Patricia Horcajada Dr. |
| | Gérard Férey, Ruxandra Gref, Patrick Couvreur, Christian |
| | Serre. BioMOFs: Metal-Organic Frameworks for Biological |
| | and Medical Applications, Angew. Chem. Int. Ed. 2010, 49, |
| | 6260-6266 |
| 21 | A. D. Firmino; R. F. Mendes; J. P. Tome; F. A. Almeida Paz, |
| | Synthesis of MOFs at the Industrial Scale. Metal-Organic |
| | Frameworks: Applications in Separations and Catalysis 2018, |
| | 57-80 |
| 22 | Anastasia Permyakova, Oleksandr Skrylnyk, Emilie Courbon, |
| | Maame Affram, Sujing Wang, U-Hwang Lee, Anil H. Valekar, |
| | Farid Nouar, Georges Mouchaham, Thomas Devic, Guy De |
| | Weireld, Jong-San Chang, Nathalie Steunou, Marc FrHre, |
| | Christian Serre, Synthesis Optimization, Shaping, and Heat |
| | Reallocation Evaluation of the Hydrophilic Metal-Organic |
| | Framework MIL-160(Al), ChemSusChem 2017, 10, 1419- |
| | 1426 |
| 23 | C. Serre, F. Millange, C. Thouvenot, M. Nogues, G. Marsolier, |
| | D. Louer, G. Ferey, Very Large Breathing Effect in the First |
| | Nanoporous Chromium(III)-Based Solids: MIL-53 or |
| | CrIII(OH)•{O2C—C6H4—CO2}•{HO2C—C6H4—CO2H}x•H2 |
| | Oy, J. Am. Chem. Soc. 2002, 124, 13519-13526 |
| 24 | G. Ferey, C. Mellot-Draznieks, C. Serre, F. Millange, J. Dutour, |
| | S. Surble, I. Margiolaki, A Chromium Terephthalate-Based |
| | Solid with Unusually Large Pore Volumes and Surface Area, |
| | Science 2005, 309, 2040-2042 |
| 25 | Sk Md Towsif Abtab, Dalal Alezi, Prashant M. Bhatt, |
| | Aleksander Shkurenko, Youssef Belmabkhout, Himanshu |
| | Aggarwal, Łukasz J. Weseli nski, Norah Alsadun, Umer Samin, |
| | Mohamed Nejib Hedhili, and Mohamed Eddaoudi, Reticular |
| | Chemistry in Action: A Hydrolytically Stable MOF Capturing |
| | Twice Its Weight in Adsorbed Water, Chem, 2018, 4, 94-105 |
| 26 | Xukun Qian, Boluo Yadian, Renbing Wu, Yi Long, Kun Zhou, |
| | Bin Zhu, Yizhong Huang, Structure stability of metal-organic |
| | framework MIL-53 (Al) in aqueous solutions, International |
| | Journal of Hydrogen Energy, 2013, 38, 16710 |
| 27 | Thierry Loiseau, Christian Serre, Clarisse Huguenard, Gerhard |
| | Fink, Francis Taulelle, Marc Henry, Thierry Bataille, and |
| | Gÿrard Fÿrey, A Rationale for the Large Breathing of the |
| | Porous Aluminum Terephthalate (MIL-53) Upon Hydration, |
| | Chem. Eur. J. 2004, 10, 1373- 1382 |
| 28 | Anne Boutin, François-Xavier Coudert, Marie-Anne |
| | Springuel-Huet, Alexander V. Neimark, Gérard Férey, and |
| | Alain H. Fuchs, The Behavior of Flexible MIL-53(Al) upon |
| | CH4 and CO2 Adsorption, J. Phys. Chem. C, 2010, 114, |
| | 22237-22244 |
| 29 | Prashant Mishra, Hari Prasad Uppara, Bishnupada Mandal*, |
| | and Sasidhar Gumma, Adsorption and Separation of Carbon |
| | Dioxide Using MIL-53(Al) Metal-Organic Framework, Ind. |
| | Eng. Chem. Res. 2014, 53, 19747-19753 |
| 30 | Sarah Couck, Joeri F. M. Denayer, Gino V. Baron, Tom Rémy, |
| | Jorge Gascon, and Freek Kapteijn, An Amine-Functionalized |
| | MIL-53 Metal-Organic Framework with Large Separation |
| | Power for CO2 and CH4, J. Am. Chem. Soc. 2009, 131, 6326- |
| | 6327 |
| 31 | Linius Bolinois, a Tanay Kundu, a Xuerui Wang, a Yuxiang |
| | Wang, a Zhigang Hu, ORCID logo a Kenny Koha and Dan |
| | Zhao, Breathing-induced new phase transition in an MIL- |
| | 53(Al)—NH2 metal-organic framework under high methane |
| | pressures |
| 32 | Ehsan Rahmani, and Mohammad Rahmani, Al-based MIL-53 |
| | Metal Organic Framework (MOF) as the New Catalyst for |
| | Friedel-Crafts Alkylation of Benzene, Ind. Eng. Chem. Res. |
| | 2018, 57, 169-178 |
| 33 | Zhengyan Wang, Melike Babucci, Yafeng Zhang, Yujie Wen, |
| | Luming Peng, Bing Yang, Bruce C. Gates, and Dong Yang, |
| | Dialing in Catalytic Sites on Metal Organic Framework Nodes: |
| | MIL53(Al) and MIL-68(Al) Probed with Methanol |
| | Dehydration Catalysis, ACS Appl. Mater. Interfaces 2020, 12, |
| | 53537-53546 |
| 34 | Cheng-Xiong Yang, Hu-Bo Ren, and Xiu-Ping Yan, |
| | Fluorescent Metal-Organic Framework MIL-53(Al) for Highly |
| | Selective and Sensitive Detection of Fe3+ in Aqueous Solution, |
| | Anal. Chem. 2013, 85, 15, 7441-7446 |
| 35 | P. G. Yot, Z. Boudene, J. Macia, D. Granier, L. Vanduy uys, T. |
| | Verstraelen, V. van Speybroeck, T. Devic, C. Serre, G. F′erey, |
| | N. Stock and G. Maurin, Chem. Commun., 2014, 50, 9462 |
| 36 | Pablo Serra-Crespo, Monique A. van der Veen, Elena |
| | Gobechiya, Kristof Houthoofd, Yaroslav Filinchuk, Christine |
| | E. A. Kirschhock, Johan A. Martens, Bert F. Sels, Dirk E. De |
| | Vos, Freek Kapteijn, and Jorge Gascon, NH2-MIL-53(Al): A |
| | High-Contrast Reversible Solid-State Nonlinear Optical |
| | Switch, J. Am. Chem. Soc. 2012, 134, 8314-8317 |
| 37 | Nicolas Chanut, Aziz Ghoufi, Marie-Vanessa Coulet, Sandrine |
| | Bourrelly, Bodgan Kuchta, Guillaume Maurin & Philip L. |
| | Llewellyn, Tailoring the separation properties of flexible metal- |
| | organic frameworks using mechanical pressure. Nat Commun, |
| | 2020, 11, 1216 |
| 38 | Antonio Zárate, Ricardo A. Peralta, Peter A. Bayliss, Rowena |
| | Howie, Mayra Sánchez-Serratos, Paulina Carmona-Monroy, |
| | Diego Solis-Ibarra, Eduardo González-Zamora and Ilich A. |
| | Ibarra, CO2 capture under humid conditions in NH2-MIL- |
| | 53(Al): the influence of the amine functional group, RSC Adv., |
| | 2016, 6, 9978-9983 |
| 39 | Mayra Sánchez-Serratos, Peter A. Bayliss, Ricardo A. Peralta, |
| | Eduardo González-Zamora, Enrique Limaa and Ilich A. Ibarra, |
| | CO2 capture in the presence of water vapour in MIL-53(Al), |
| | New J. Chem., 2016, 40, 68-72 |
| 40 | Gerardo A. González-Martínez, J. Antonio Zárate, Ana |
| | Martinez, Elí Sánchez-González, J. Raziel Álvarez, Enrique |
| | Lima, Eduardo González-Zamora and Ilich A. Ibarra, |
| | Confinement of alcohols to enhance CO2 capture in MIL- |
| | 53(Al), RSC Adv., 2017, 7, 24833-24840 |
| 41 | Tanay Kundu, Mohammad Wahiduzzaman, Bhuvan B. Shah, |
| | Guillaume Maurin, and Dan Zhao, Solvent-Induced Control |
| | over Breathing Behavior in Flexible Metal- Organic |
| | Frameworks for Natural-Gas Delivery, Angew. Chem. Int. Ed. |
| | 2019, 58, 8073-8077 |
| 42 | Christopher W. Ashling, Duncan N. Johnstone, Remo N. |
| | Widmer, Jingwei Hou, Sean M. Collins, Adam F. Sapnik, Alice |
| | M. Bumstead, Paul A. Midgley, Philip A. Chater, David A. |
| | Keen, and Thomas D. Bennett, Synthesis and Properties of a |
| | Compositional Series of MIL-53(Al) Metal-Organic |
| | Framework Crystal-Glass Composites, J. Am. Chem. Soc. |
| | 2019, 141, 15641-15648 |
| 43 | Manuel Sánchez-Sánchez, Negash Getachew, Kenya Díaz, |
| | Manuel Díaz-García, Yonas Chebude and Isabel Díaz, |
| | Synthesis of metal-organic frameworks in water at room |
| | temperature: salts as linker sources, Green Chem., 2015, 17, |
| | 1500-1509 |
| 44 | Shyam Biswas, Tim Ahnfeldt, and Norbert Stock, New |
| | Functionalized Flexible Al-MIL-53-X (X = —Cl, —Br, —CH3, —NO2, —(OH)2) |
| | Solids: Syntheses, Characterization, Sorption, |
| | and Breathing Behavior, Inorg. Chem. 2011, 50, 9518-9526 |
| 45 | Besverkhyy I. et al., Degradation of fluoride-free MIL-100(Fe) |
| | and MIL-53(Fe) in water: effect of temperature and pH, |
| | Microporous and mesoporous materials 2015, 219, 117-124 |
| 46 | Bhardwaj Neha et al., MOF-Bacteriophage Biosensor For |
| | Highly Sensitive and Specific Detection of Staphylococcus |
| | aureus, Applied Materials and Interfaces 2017, 9, 33589-33598 |
| 47 | Anokhina Ekaterina V. et al., In(OH)BDC•0.75BDCH 2 (BDC = |
| | Benzenedicarboxylate, a Hybrid Inorganic-Organic Vernier |
| | Structure, Journal of the American Chemical Society 2005, |
| | 127, 15000-15001 |
| 48 | RU 2 578 600-C1 |

1. A method for producing a metal-organic framework (MOF), a MOF being a structured metal-organic compound comprising a bi- or tri-dimensional porous framework consisting of inorganic entities connected by polydentate chelating ligands bonded to a plurality of metal centers; said polydentate chelating ligands being selected from the group consisting of:
C₄-C₂₄ aliphatic ligands comprising at least one carboxylic acid function, selected from ligands comprising a linear alkyl chain without unsaturation, or ligands comprising carbon chains including at least one unsaturation;
C₅-C₂₄ heteroaromatic ligands and aromatic ligands comprising at least one carboxylic acid function, optionally benzyl or naphthyl di-, tri- or tetracarboxylate, and said aromatic or heteroaromatic ligands, optionally bearing on at least one aromatic ring, a group selected from —NH₂, —OH, —CH₃, —OCH₃, —NO₂, —CF₃, —COOH, —SO₃H, —SH; said method comprising:
a) dispersing in water a molecule of polydentate chelating ligand, and at least one metal salt to obtain a dispersion;
b) optionally heating the dispersion obtained in a) at ambient pressure and maintaining it at a temperature of 50 to 150° C., for a period from 10 minutes to 96 hours;
c) allowing to return to ambient temperature, filtering and washing the solid obtained with water;
d) drying the solid obtained in c); and
e) dispersing under stirring the solid obtained in d) in a solution comprising DMSO for a period from 30 minutes to 15 hours, at a temperature less than or equal to 150° C.

2. The method according to claim 1, wherein the metallic center comprises at least one metal selected from Cu, Zn, Ca, Mg, Ti, Zr, In, Ga, V, Cr, Mn, Fe and/or Al.

3. The method according to claim 1, wherein the MOF is selected from MIL-53, MIL-68, MIL-69, MIL-101, MIP-206, or DUT-7.

4. The method according to claim 1, wherein the MOF is selected from the MIL-53 class comprising a metal ion in oxidation state +3 of a metal selected from Cr, Al, Fe, V, Ga or In, and the aromatic ligand is benzene-1,4-dicarboxylic acid or a derivative thereof.

5. The method according to claim 4, wherein the 1,4-benzene dicarboxylic acid derivative is 1,4-benzene dicarboxylic acid substituted on the aromatic ring with at least one group selected from: —NH₂, —OH and/or —NO₂.

6. The method according to claim 1, wherein the metal sulphate implemented in step a) is Al₂(SO₄)₃·16H₂O, and optionally urea is added to the dispersion in step a).

7. The method according to claim 1, wherein the metal chlorate implemented in step a) is FeCl₃·6H₂O.

8. The method according to claim 1, wherein step b) is maintained for 8 hours and 48 hours; and in step e) the dispersion is heated to a temperature of less than or equal to 130° C. for 1 to 4 h, under mechanical stirring.

9. An MOF of the MIL-53 class, selected from MIL-53(Al), MIL-53(Al)—NH₂, MIL-53(Al)—NO₂, MIL-53(Al)—OH, MIL-53(Fe) or MIL-53(Cr), prepared according to the method in according to claim 1 without the use of DMF, and not involving a calcination step.

10. A method for separation of gases or vapors; capture of CO₂; separation of aromatics, aliphatics; capture of volatile organic compounds; water-alcohol purification; desalination, the materials for batteries; catalysis optionally for dehydrogenation of alcohols; adsorption and conversion of small molecules; management of the heat lost optionally by adsorption-compensation; and/or separation or the controlled storage/release by stimuli comprising using the MOF according to claim 9.

11. The method according to claim 1, wherein the at least one metal salt is selected from metal sulphate salts or metal chlorate salts.

12. The method according to claim 11, wherein the metal sulphate salt is aluminium sulphate salt.
